(19) United States
(12) Patent Application Publication
(10) Pub. No.: US 2025/0044553 A1
(43) Pub. Date: Feb. 6, 2025

(54) OPTICAL LENS ASSEMBLY AND PHOTOGRAPHING MODULE

(71) Applicant: NEWMAX TECHNOLOGY CO., LTD., Taichung City (TW)

(72) Inventor: Chia-Wei LIAO, Taichung City (TW)

(21) Appl. No.: 18/387,467

(22) Filed: Nov. 7, 2023

(30) Foreign Application Priority Data
Jul. 31, 2023 (TW) 112128649

(51) Int. Cl. G02B 9/62; G02B 13/00; G02B 13/06

(52) U.S. Cl. CPC G02B 9/62; G02B 13/0045; G02B 13/06

(57) ABSTRACT

An optical lens assembly includes a stop, and includes, in order from the object side to the image side: a first lens, a second lens, a third lens, a fourth lens, a fifth lens, and a sixth lens; wherein a refractive index of the third lens is nd3, a central thickness of the third lens along the optical axis is CT3, an entrance pupil diameter of the optical lens assembly is EPD, and the following condition is satisfied: 2.64□(nd3*CT3)/EPD□4.55.

### CROSS-REFERENCE TO RELATED APPLICATION

This application claims the benefit of Taiwan Patent Application No. 112128649, filed on Jul. 31, 2023, which is hereby incorporated by reference for all purposes as if fully set forth herein.

### BACKGROUND

### Technical Field

The present disclosure relates to an optical lens assembly and a photographing module, and in particular, to an optical lens assembly and a photographing module applicable to an electronic device.

### Related Art

In recent years, related equipment such as a lens module of a network camera (IPCAM) and a lens module of an aerial camera have achieved great development; however, these applications still lack wide-angle lens modules with large apertures that can take into account both visible and infrared light bands. In addition, for the designs of the wide-angle lens module in the prior art, generally there is no larger image height. If the wide-angle lens module is used with an image sensing element having a large effective area, the vignetting effect is easy to occur. Furthermore, to solve the image problem caused by temperature change, it is usually necessary to use a design with plurality of glass lenses, which will increases the cost.

In detail, the wide-angle lens modules with large aperture in the prior art are rarely able to meet the needs of both visible and infrared light bands; the design of wide-angle lens module in the prior art generally have no larger image height, which limits the size of the available image sensing elements, and the vignetting effect may occur. Furthermore, for image problems caused by temperature change, a common solution is to use a design with plurality of glass lenses, but it increases cost and complexity.

### SUMMARY

An objective of the present disclosure is to resolve the above problems of the prior art. In order to achieve the above objective, the present disclosure provides an optical lens assembly comprising a stop, and in order from an object side to an image side, comprising: a first lens with negative refractive power, comprising an object-side surface and an image-side surface, wherein the object-side surface of the first lens is concave near the optical axis; a second lens with negative refractive power, comprising an object-side surface and an image-side surface; a third lens with positive refractive power, comprising an object-side surface and an image-side surface; a fourth lens with positive refractive power, comprising an object-side surface and an image-side surface; a fifth lens with negative refractive power, comprising an object-side surface and an image-side surface; and a sixth lens with positive refractive power, comprising an object-side surface and an image-side surface.

A total quantity of lenses with refractive power in the optical lens assembly is six. A refractive index of the third lens is nd3, a central thickness of the third lens along the optical axis is CT3, an entrance pupil diameter of the optical lens assembly is EPD, and the following condition is satisfied: 2.64□(nd3*CT3)/EPD□4.55.

When the optical lens assembly satisfies the conditions of 2.64□(nd3*CT3)/EPD□4.55, by selecting the material of the third lens, and using the appropriate configuration of the thickness of the third lens and the entrance pupil diameter, the manufacturability of the optical lens assembly can be improved, and simultaneously the impact of temperature change on imaging quality can be reduced.

An Abbe number of the third lens is vd3, a refractive index of the third lens is nd3, a focal length of the third lens is f3, and the following condition is satisfied: 0.82 mm⁻¹<vd3/(nd3*f3)<2.81 mm⁻¹. By selecting the third lens material, and using the appropriate configuration of the refractive power, the image quality of the optical lens assembly can be improved.

An Abbe number of the third lens is vd3, a sum of the distances between any two adjacent lenses along the optical axis is ΣAT, a refractive index of the third lens is nd3, a focal length of the third lens is f3, and the following condition is satisfied: 4.55□(vd3*ΣAT)/(nd3*f3)□18.52. By selecting the material of the third lens, and using the appropriate configuration of the refractive power and the distances between any two adjacent lenses of the optical lens assembly, the third lens has better formability to be manufactured easily and reduce the production cost.

A composite focal length of the fourth lens, the fifth lens and the sixth lens is f456, a focal length of the optical lens assembly is f, an entrance pupil diameter of the optical lens assembly is EPD, and the following condition is satisfied: 0.81 mm⁻¹<f456/(f*EPD)<1.31 mm⁻¹. By using the appropriate configuration of the refractive power and the entrance pupil diameter of the optical lens assembly, it is conducive to improving the confocal performance of the optical lens assembly in the visible light band and infrared light band.

A sum of the distances between any two adjacent lenses along the optical axis is ΣAT, a central thickness of the second lens along the optical axis is CT2, a central thickness of the third lens along the optical axis is CT3, and the following condition is satisfied: 15.68 mm□ΣAT*CT3/(CT2)□43.12 mm. By using the appropriate configuration of lens thickness and the distances between any two adjacent lenses, it helps to reduce the sensitivity of the optical lens assembly and reduce assembly tolerances.

A curvature radius of the object-side surface of the third lens is R5, a curvature radius of the object-side surface of the fourth lens is R7, an entrance pupil diameter of the optical lens assembly is EPD, and the following condition is satisfied: 1.04 mm□(R5/R7)*EPD□22.66 mm. By using the appropriate configuration of the ratio between the lens curvature and the entrance pupil diameter can effectively reduce the temperature drift caused by temperature change to ensure excellent image quality.

A distance from the object-side surface of the first lens to the image plane along the optical axis is TL, a distance from the image-side surface of the second lens to the object-side surface of the third lens along the optical axis is T23, a distance from the image-side surface of the fifth lens to the object-side surface of the sixth lens along the optical axis is T56, and the following condition is satisfied: 32.06□TL/(T23+T56)□102.41. In this way, it makes the lens spacing configuration and the height of the optical lens assembly more appropriate, thereby reducing the ghost reflection problem of the optical lens assembly.

A focal length of the third lens is f3, a central thickness of the third lens along the optical axis is CT3, a curvature radius of the object-side surface of the third lens is R5, and the following condition is satisfied: 0.33 mm□f3*CT3/R5□2.55 mm. In this way, the appropriate configuration of various parameters of the third lens can helpfully improve the manufacturability of the optical lens assembly and reduce the impact of temperature change on image quality.

A curvature radius of the object-side surface of the fifth lens is R9, a focal length of the fourth lens is f4, a focal length of the fifth lens is f5, and the following condition is satisfied: −6.61 mm⁻¹□R9/(f4*f5)□−0.25 mm⁻¹. In this way, the appropriate configuration of the refractive power and curvature of the lenses can helpfully improve the confocal performance of the optical lens assembly in the visible light band and the infrared light band.

An incident angle where a chief ray is incident on an image plane at a maximum view angle of the optical lens assembly is CRA, a curvature radius of the object-side surface of the fifth lens is R9, a maximum field of view of the optical lens assembly is FOV, and the following condition is satisfied: 1.12 mm□CRA*R9/FOV□30.28 mm. In this way, the configuration of the incident angle of the chief ray of the optical lens assembly and the lens curvature are more appropriate, so that the optical lens assembly has an ultra-wide angle and is easy to correct aberrations of the optical lens assembly.

An incident angle where a chief ray is incident on an image plane at a maximum view angle of the optical lens assembly is CRA, a curvature radius of the object-side surface of the third lens is R5, a maximum image height of the optical lens assembly is IMH, and the following condition is satisfied: 0.47<tan(CRA)*R5/IMH<6.35. In this way, the incident angle of the chief ray, lens curvature and image height of the optical lens assembly are configured more appropriately to achieve the best image quality.

An incident angle where a chief ray is incident on an image plane at a maximum view angle of the optical lens assembly is CRA, a curvature radius of the object-side surface of the fourth lens is R7, a curvature radius of the object-side surface of the fifth lens is R9, a distance from the image-side surface of the sixth lens to the image plane along the optical axis is BFL, a focal length of the optical lens assembly is f, and the following condition is satisfied: 0.02°/mm²<(CRA*R7)/(R9*BFL*f)<1.79°/mm². In this way, the incident angle of the chief ray, the curvature and refractive power of the lenses, and the back focus space are optimally configured, so that the optical lens assembly has better relative illumination and meets the back focus requirements of the optical lens assembly.

A curvature radius of the object-side surface of the first lens is R1, a curvature radius of the image-side surface of the second lens is R4, a distance from the image-side surface of the sixth lens to the image plane along the optical axis is BFL, and the following condition is satisfied: −106.64 mm<(R1/R4)*BFL<−29.68 mm. In this way, the lens curvature and back focus space are appropriately configured to meet the requirement of the back focus of the optical lens assembly and improve the image quality of the optical lens assembly.

A maximum field of view of the optical lens assembly is FOV, a curvature radius of the object-side surface of the first lens is R1, a curvature radius of the object-side surface of the third lens is R5, and the following condition is satisfied: −258.69°<(FOV/R1)*R5<−8.76°. In this way, the appropriate configuration of the maximum viewing angle and lens curvature can effectively enhance its wide angle characteristics and provide a larger viewing angle, which helpfully improve the image quality of the optical lens assembly.

A curvature radius of the object-side surface of the third lens is R5, a curvature radius of the image-side surface of the third lens is R6, and the following condition is satisfied: −9.85<R5/R6<−0.67. In this way, the appropriate configuration of the curvature of the third lens helpfully improves the manufacturability of the third lens.

A focal length of the second lens is f2, a focal length of the third lens is f3, and the following condition is satisfied: −1.96<f2/f3<−0.87. In this way, the refractive powers of lenses of the optical lens assembly have a better configuration, and simultaneously reduce the impact of temperature change on image quality.

An incident angle where a chief ray is incident on an image plane at a maximum view angle of the optical lens assembly is CRA, a central thickness of the second lens along the optical axis is CT2, a central thickness of the fourth lens along the optical axis is CT4, a central thickness of the fifth lens along the optical axis is CT5, a central thickness of the sixth lens along the optical axis is CT6, and the following condition is satisfied: 5.40 mm<(CT4+CT5+CT6)*EPD/CT2<14.83 mm. In this way, the lens thickness and the entrance pupil diameter are optimally configured to reduce assembly tolerances and improve the image quality of the optical lens assembly.

In addition, the present disclosure further provides a photographing module. The photographing module comprises: a lens barrel; an optical lens assembly disposed in the lens barrel; and an image sensor disposed on an image plane of the optical lens assembly.

The optical lens assembly comprises a stop, and in order from an object side to an image side, comprising: a first lens with negative refractive power, comprising an object-side surface and an image-side surface, wherein the object-side surface of the first lens is concave near the optical axis; a second lens with negative refractive power, comprising an object-side surface and an image-side surface; a third lens with positive refractive power, comprising an object-side surface and an image-side surface; a fourth lens with positive refractive power, comprising an object-side surface and an image-side surface; a fifth lens with negative refractive power, comprising an object-side surface and an image-side surface; and a sixth lens with positive refractive power, comprising an object-side surface and an image-side surface.

A total quantity of lenses with refractive power in the optical lens assembly is six. A refractive index of the third lens is nd3, a central thickness of the third lens along the optical axis is CT3, an entrance pupil diameter of the optical lens assembly is EPD, and the following condition is satisfied: 2.64□(nd3*CT3)/EPD□4.55.

When the optical lens assembly satisfies the conditions of 2.64□(nd3*CT3)/EPD□4.55, by selecting the material of the third lens, and using the appropriate configuration of the thickness of the third lens and the entrance pupil diameter, the manufacturability of the optical lens assembly can be improved, and simultaneously the impact of temperature change on imaging quality can be reduced.

An Abbe number of the third lens is vd3, a refractive index of the third lens is nd3, a focal length of the third lens is f3, and the following condition is satisfied: 0.82 mm⁻¹<vd3/(nd3*f3)<2.81 mm⁻¹. By selecting the third lens material, and using the appropriate configuration of the refractive power, the image quality of the optical lens assembly can be improved.

an Abbe number of the third lens is vd3, a sum of the distances between any two adjacent lenses along the optical axis is ΣAT, a refractive index of the third lens is nd3, a focal length of the third lens is f3, and the following condition is satisfied: 4.55□(vd3*ΣAT)/(nd3*f3)□18.52. By selecting the material of the third lens, and using the appropriate configuration of the refractive power and the distances between any two adjacent lenses of the optical lens assembly, the third lens has better formability to be manufactured easily and reduce the production cost.

A composite focal length of the fourth lens, the fifth lens and the sixth lens is f456, a focal length of the optical lens assembly is f, an entrance pupil diameter of the optical lens assembly is EPD, and the following condition is satisfied: 0.81 mm⁻¹<f456/(f*EPD)<1.31 mm⁻¹. By using the appropriate configuration of the refractive power and the entrance pupil diameter of the optical lens assembly, it is conducive to improving the confocal performance of the optical lens assembly in the visible light band and infrared light band.

A sum of the distances between any two adjacent lenses along the optical axis is ΣAT, a central thickness of the second lens along the optical axis is CT2, a central thickness of the third lens along the optical axis is CT3, and the following condition is satisfied: 15.68 mm□ΣAT*CT3/(CT2)□43.12 mm. By using the appropriate configuration of lens thickness and the distances between any two adjacent lenses, it helps to reduce the sensitivity of the optical lens assembly and reduce assembly tolerances.

A curvature radius of the object-side surface of the third lens is R5, a curvature radius of the object-side surface of the fourth lens is R7, an entrance pupil diameter of the optical lens assembly is EPD, and the following condition is satisfied: 1.04 mm□(R5/R7)*EPD□22.66 mm. By using the appropriate configuration of the ratio between the lens curvature and the entrance pupil diameter can effectively reduce the temperature drift caused by temperature change to ensure excellent image quality.

A distance from the object-side surface of the first lens to the image plane along the optical axis is TL, a distance from the image-side surface of the second lens to the object-side surface of the third lens along the optical axis is T23, a distance from the image-side surface of the fifth lens to the object-side surface of the sixth lens along the optical axis is T56, and the following condition is satisfied: 32.06□TL/(T23+T56)□102.41. In this way, it makes the lens spacing configuration and the height of the optical lens assembly more appropriate, thereby reducing the ghost reflection problem of the optical lens assembly.

A focal length of the third lens is f3, a central thickness of the third lens along the optical axis is CT3, a curvature radius of the object-side surface of the third lens is R5, and the following condition is satisfied: 0.33 mm□f3*CT3/R5□2.55 mm. In this way, the appropriate configuration of various parameters of the third lens can helpfully improve the manufacturability of the optical lens assembly and reduce the impact of temperature change on image quality.

A curvature radius of the object-side surface of the fifth lens is R9, a focal length of the fourth lens is f4, a focal length of the fifth lens is f5, and the following condition is satisfied: −6.61 mm⁻¹□R9/(f4*f5)□−0.25 mm⁻¹. In this way, the appropriate configuration of the refractive power and curvature of the lenses can helpfully improve the confocal performance of the optical lens assembly in the visible light band and the infrared light band.

An incident angle where a chief ray is incident on an image plane at a maximum view angle of the optical lens assembly is CRA, a curvature radius of the object-side surface of the fifth lens is R9, a maximum field of view of the optical lens assembly is FOV, and the following condition is satisfied: 1.12 mm□CRA*R9/FOV□30.28 mm. In this way, the configuration of the incident angle of the chief ray of the optical lens assembly and the lens curvature are more appropriate, so that the optical lens assembly has an ultra-wide angle and is easy to correct aberrations of the optical lens assembly.

An incident angle where a chief ray is incident on an image plane at a maximum view angle of the optical lens assembly is CRA, a curvature radius of the object-side surface of the third lens is R5, a maximum image height of the optical lens assembly is IMH, and the following condition is satisfied: 0.47<tan(CRA)*R5/IMH<6.35. In this way, the incident angle of the chief ray, lens curvature and image height of the optical lens assembly are configured more appropriately to achieve the best image quality.

An incident angle where a chief ray is incident on an image plane at a maximum view angle of the optical lens assembly is CRA, a curvature radius of the object-side surface of the fourth lens is R7, a curvature radius of the object-side surface of the fifth lens is R9, a distance from the image-side surface of the sixth lens to the image plane along the optical axis is BFL, a focal length of the optical lens assembly is f, and the following condition is satisfied: 0.02°/mm²<(CRA*R7)/(R9*BFL*f)<1.79°/mm². In this way, the incident angle of the chief ray, the curvature and refractive power of the lenses, and the back focus space are optimally configured, so that the optical lens assembly has better relative illumination and meets the back focus requirements of the optical lens assembly.

A curvature radius of the object-side surface of the first lens is R1, a curvature radius of the image-side surface of the second lens is R4, a distance from the image-side surface of the sixth lens to the image plane along the optical axis is BFL, and the following condition is satisfied: −106.64 mm<(R1/R4)*BFL<−29.68 mm. In this way, the lens curvature and back focus space are appropriately configured to meet the requirement of the back focus of the optical lens assembly and improve the image quality of the optical lens assembly.

A maximum field of view of the optical lens assembly is FOV, a curvature radius of the object-side surface of the first lens is R1, a curvature radius of the object-side surface of the third lens is R5, and the following condition is satisfied: −258.69°<(FOV/R1)*R5<−8.76°. In this way, the appropriate configuration of the maximum viewing angle and lens curvature can effectively enhance its wide angle characteristics and provide a larger viewing angle, which helpfully improve the image quality of the optical lens assembly.

A curvature radius of the object-side surface of the third lens is R5, a curvature radius of the image-side surface of the third lens is R6, and the following condition is satisfied: −9.85<R5/R6<−0.67. In this way, the appropriate configuration of the curvature of the third lens helpfully improves the manufacturability of the third lens.

A focal length of the second lens is f2, a focal length of the third lens is f3, and the following condition is satisfied: −1.96<f2/f3<−0.87. In this way, the refractive powers of lenses of the optical lens assembly have a better configuration, and simultaneously reduce the impact of temperature change on image quality.

An incident angle where a chief ray is incident on an image plane at a maximum view angle of the optical lens assembly is CRA, a central thickness of the second lens along the optical axis is CT2, a central thickness of the fourth lens along the optical axis is CT4, a central thickness of the fifth lens along the optical axis is CT5, a central thickness of the sixth lens along the optical axis is CT6, and the following condition is satisfied: 5.40 mm<(CT4+CT5+CT6)*EPD/CT2<14.83 mm. In this way, the lens thickness and the entrance pupil diameter are optimally configured to reduce assembly tolerances and improve the image quality of the optical lens assembly.

### BRIEF DESCRIPTION OF THE DRAWINGS

FIG. 1A is a schematic view of an optical lens assembly according to a first embodiment of the present disclosure.

FIG. 1B sequentially shows a field curvature curve and a distortion curve of an optical lens assembly according to a first embodiment.

FIG. 2A is a schematic view of an optical lens assembly according to a second embodiment of the present disclosure.

FIG. 2B sequentially shows a field curvature curve and a distortion curve of an optical lens assembly according to a second embodiment.

FIG. 3A is a schematic view of an optical lens assembly according to a third embodiment of the present disclosure of the present disclosure.

FIG. 3B shows a field curvature curves and a distortion curve of the optical lens assembly according to the third embodiment.

FIG. 4A is a schematic view of an optical lens assembly according to a fourth embodiment of the present disclosure of the present disclosure.

FIG. 4B shows a field curvature curves and a distortion curve of the optical lens assembly according to the fourth embodiment.

FIG. 5A is a schematic view of an optical lens assembly according to a fifth embodiment of the present disclosure of the present disclosure.

FIG. 5B shows a field curvature curves and a distortion curve of the optical lens assembly according to the fifth embodiment.

FIG. 6 is a schematic view of a photographing module according to a seventh embodiment of the present disclosure.

### DETAILED DESCRIPTION

In order to enable a person of ordinary skill in the art to understand and realize the contents of the present disclosure, the following are illustrated by proper embodiments with accompanying drawings, and the equivalent substitutions and modifications based on the contents of the present disclosure are included in the scope of the present disclosure. It is also stated that the accompanying drawings of the present disclosure are not depictions of actual dimensions, and although the present disclosure provides embodiments of particular parameters, it is to be understood that the parameters need not be exactly equal to their corresponding values, and that, within an acceptable margin of error, are approximate to their corresponding parameters. The following embodiments will further detail the technical aspects of the present disclosure, but the disclosure is not intended to limit the scope of the present disclosure.

### First Embodiment

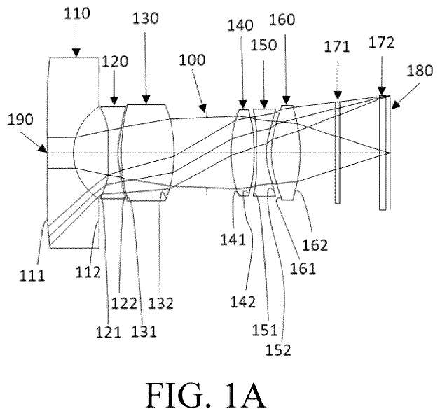

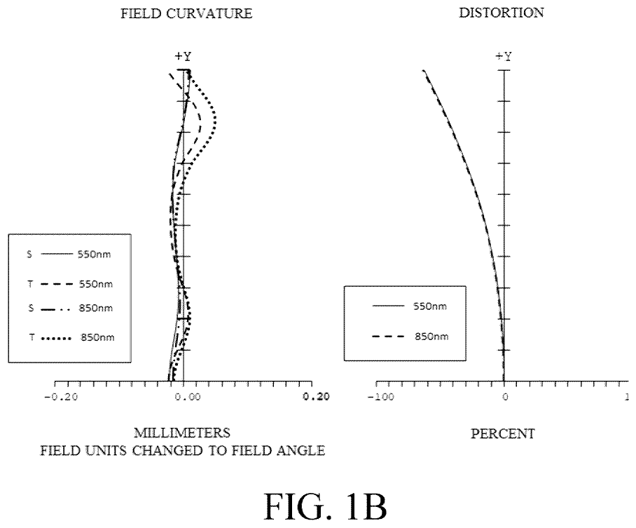

Refer to FIG. 1A and FIG. 1B. FIG. 1A is a schematic view of an optical lens assembly according to a first embodiment of the present disclosure, and FIG. 1B shows a field curvature curve and a distortion curve of an optical lens assembly according to a first embodiment. As can be seen from FIG. 1A, the optical lens assembly includes, in order from an object side to an image side: a first lens 110, a second lens 120, a third lens 130, a stop 100, a fourth lens 140, a fifth lens 150, a sixth lens 160, an optical filter 171, a protective element 172, and an image plane 180. A total quantity of lenses with refractive power in the optical lens assembly is six, but not limited thereto.

The first lens 110 with negative refractive power is made of a plastic material and includes an object-side surface 111 and an image-side surface 112, wherein the object-side surface 111 of the first lens 110 is concave near an optical axis 190, and the image-side surface 112 of the first lens 110 is concave near the optical axis 190. The object-side surface 111 and the image-side surface 112 are aspheric.

The second lens 120 with negative refractive power is made of a plastic material and includes an object-side surface 121 and an image-side surface 122, wherein the object-side surface 121 of the second lens 120 is convex near the optical axis 190, and the image-side surface 122 of the second lens 120 is concave near the optical axis 190. The object-side surface 121 and the image-side surface 122 are aspheric.

The third lens 130 with positive refractive power is made of a glass material and includes an object-side surface 131 and an image-side surface 132, wherein the object-side surface 131 of the third lens 130 is convex near an optical axis 190, and the image-side surface 132 of the third lens 130 is convex near the optical axis 190. The object-side surface 131 and the image-side surface 132 are aspheric.

The fourth lens 140 with positive refractive power is made of a plastic material and includes an object-side surface 141 and an image-side surface 142, wherein the object-side surface 141 of the fourth lens 140 is convex near an optical axis 190, and the image-side surface 142 of the fourth lens 140 is convex near the optical axis 190. The object-side surface 141 and the image-side surface 142 are aspheric.

The fifth lens 150 with negative refractive power is made of a plastic material and includes an object-side surface 151 and an image-side surface 152, wherein the object-side surface 151 of the fifth lens 150 is convex near the optical axis 190, and the image-side surface 152 of the fifth lens 150 is concave near the optical axis 190. The object-side surface 151 and the image-side surface 152 are aspheric.

The sixth lens 160 with positive refractive power is made of a plastic material and includes an object-side surface 161 and an image-side surface 162, wherein the object-side surface 161 of the sixth lens 160 is convex near the optical axis 190, and the image-side surface 162 of the sixth lens 160 is convex near the optical axis 190. The object-side surface 161 and the image-side surface 162 are aspheric.

The optical filter 171 is made of glass, and is disposed between the sixth lens 160 and the image plane 180 without affecting a focal length of the optical lens assembly. In this embodiment, the optical filter 171 may be an optical filter that allows the visible light to pass, an optical filter that allows the infrared light to pass, or an optical filter that allows the visible light and the infrared light to pass simultaneously.

The protective element 172 is made of glass, and is disposed between the optical filter 171 and the image plane 180 without affecting a focal length of the optical lens assembly.

An aspheric curve equation of the above-mentioned lenses is expressed as follows:

$$z ( h ) = \frac{{ch}^{2}}{1 + {[ 1 - ( k + 1 ) {c}^{2} {h}^{2} ]}^{0.5}} + \sum ( {A}_{i} ) \cdot ( {h}^{i} )$$

wherein, z is a position value in the direction of the optical axis 190 and with a surface vertex as a reference at a position of a height h; c is a curvature of a lens surface near the optical axis 190, and is a reciprocal of a curvature radius (R) (c=1/R), R is a curvature radius of a lens surface near the optical axis 190, h is a vertical distance between the lens surface and the optical axis 190, k is a conic constant, and Ai is an i^{th} order aspheric coefficient.

In the first embodiment, a focal length of the optical lens assembly is f, an f-number of the optical lens assembly is Fno, and a maximum field of view in the optical lens assembly is FOV, and values are as follows: f=3.17 millimeters, Fno=1.65, and FOV=142.00°.

In the optical lens assembly of the first embodiment, a refractive index of the third lens is nd3, a central thickness of the third lens along the optical axis is CT3, an entrance pupil diameter of the optical lens assembly is EPD, and the following condition is satisfied: (nd3*CT3)/EPD=3.31.

In the optical lens assembly of the first embodiment, An Abbe number of the third lens is vd3, a refractive index of the third lens is nd3, a focal length of the third lens is f3, and the following condition is satisfied: vd3/(nd3*f3)=2.35 mm⁻¹.

In the optical lens assembly of the first embodiment, An Abbe number of the third lens is vd3, a sum of the distances between any two adjacent lenses along the optical axis is ΣAT, a refractive index of the third lens is nd3, a focal length of the third lens is f3, and the following condition is satisfied: (vd3*ΣAT)/(nd3*f3)=15.44.

In the optical lens assembly of the first embodiment, a composite focal length of the fourth lens, the fifth lens and the sixth lens is f456, a focal length of the optical lens assembly is f, an entrance pupil diameter of the optical lens assembly is EPD, and the following condition is satisfied: f456/(f*EPD)=1.09 mm⁻¹.

In the optical lens assembly of the first embodiment, a sum of the distances between any two adjacent lenses along the optical axis is ΣAT, a central thickness of the second lens along the optical axis is CT2, a central thickness of the third lens along the optical axis is CT3, and the following condition is satisfied: ΣAT*CT3/(CT2)=35.94 mm.

In the optical lens assembly of the first embodiment, a curvature radius of the object-side surface of the third lens is R5, a curvature radius of the object-side surface of the fourth lens is R7, an entrance pupil diameter of the optical lens assembly is EPD, and the following condition is satisfied: (R5/R7)*EPD=3.23 mm.

In the optical lens assembly of the first embodiment, a distance from the object-side surface of the first lens to the image plane along the optical axis is TL, a distance from the image-side surface of the second lens to the object-side surface of the third lens along the optical axis is T23, a distance from the image-side surface of the fifth lens to the object-side surface of the sixth lens along the optical axis is T56, and the following condition is satisfied: TL/(T23+T56)=40.07.

In the optical lens assembly of the first embodiment, a focal length of the third lens is f3, a central thickness of the third lens along the optical axis is CT3, a curvature radius of the object-side surface of the third lens is R5, and the following condition is satisfied: f3*CT3/R5=1.76 mm.

In the optical lens assembly of the first embodiment, A curvature radius of the object-side surface of the fifth lens is R9, a focal length of the fourth lens is f4, a focal length of the fifth lens is f5, and the following condition is satisfied: R9/(f4*f5)=−0.32 mm⁻¹.

In the optical lens assembly of the first embodiment, an incident angle where a chief ray is incident on an image plane at a maximum view angle of the optical lens assembly is CRA, a curvature radius of the object-side surface of the fifth lens is R9, a maximum field of view of the optical lens assembly is FOV, and the following condition is satisfied: CRA*R9/FOV=1.40 mm.

In the optical lens assembly of the first embodiment, An incident angle where a chief ray is incident on an image plane at a maximum view angle of the optical lens assembly is CRA, a curvature radius of the object-side surface of the third lens is R5, a maximum image height of the optical lens assembly is IMH, and the following condition is satisfied: tan(CRA)*R5/IMH=0.74.

In the optical lens assembly of the first embodiment, an incident angle where a chief ray is incident on an image plane at a maximum view angle of the optical lens assembly is CRA, a curvature radius of the object-side surface of the fourth lens is R7, a curvature radius of the object-side surface of the fifth lens is R9, a distance from the image-side surface of the sixth lens to the image plane along the optical axis is BFL, a focal length of the optical lens assembly is f, and the following condition is satisfied: (CRA*R7)/(R9*BFL*f)=0.31°/mm².

In the optical lens assembly of the first embodiment, A curvature radius of the object-side surface of the first lens is R1, a curvature radius of the image-side surface of the second lens is R4, a distance from the image-side surface of the sixth lens to the image plane along the optical axis is BFL, and the following condition is satisfied: (R1/R4)*BFL=−82.86 mm.

In the optical lens assembly of the first embodiment, a maximum field of view of the optical lens assembly is FOV, a curvature radius of the object-side surface of the first lens is R1, a curvature radius of the object-side surface of the third lens is R5, and the following condition is satisfied: (FOV/R1)*R5=−30.03°.

In the optical lens assembly of the first embodiment, A curvature radius of the object-side surface of the third lens is R5, a curvature radius of the image-side surface of the third lens is R6, and the following condition is satisfied: R5/R6=−1.52.

In the optical lens assembly of the first embodiment, a focal length of the second lens is f2, a focal length of the third lens is f3, and the following condition is satisfied: f2/f3=−1.27.

In the optical lens assembly of the first embodiment, an incident angle where a chief ray is incident on an image plane at a maximum view angle of the optical lens assembly is CRA, a central thickness of the second lens along the optical axis is CT2, a central thickness of the fourth lens along the optical axis is CT4, a central thickness of the fifth lens along the optical axis is CT5, a central thickness of the sixth lens along the optical axis is CT6, and the following condition is satisfied: (CT4+CT5+CT6)*EPD/CT2=12.36 mm.

Refer to Table 1 and Table 2 below.

TABLE 1
First embodiment
f (focal length) = 3.17 mm (millimeters), Fno (f-number) = 1.65,
FOV (field of view) = 142.00° (degrees)

| | | | | Central | | | Abbe | Focal |
|---|---|---|---|---|---|---|---|---|
| | | Curvature | | thickness/ | | Refractive | number | length |
| Surface | | radius (mm) | | gap (mm) | Material | index (nd) | (vd) | (mm) |
| 0 | Object | Infinity | | Infinity | | | | |
| 1 | First lens | −50.962 | (ASP) | 1.646 | Plastic | 1.54 | 55.99 | −5.12 |
| 2 | | 2.996 | (ASP) | 2.276 | | | | |
| 3 | Second lens | 15.834 | (ASP) | 0.631 | Plastic | 1.67 | 19.24 | −6.95 |
| 4 | | 3.575 | (ASP) | 0.227 | | | | |
| 5 | Third lens | 10.778 | | 3.445 | Glass | 1.85 | 23.78 | 5.49 |
| 6 | | −7.080 | | 2.100 | | | | |
| 7 | Stop | Infinity | | 1.549 | | | | |
| 8 | Fourth lens | 6.425 | (ASP) | 1.513 | Plastic | 1.54 | 55.99 | 8.18 |
| 9 | | −13.504 | (ASP) | 0.103 | | | | |
| 10 | Fifth lens | 14.997 | (ASP) | 0.650 | Plastic | 1.67 | 19.24 | −5.79 |
| 11 | | 3.057 | (ASP) | 0.327 | | | | |
| 12 | Sixth lens | 3.796 | (ASP) | 1.890 | Plastic | 1.54 | 55.99 | 4.94 |
| 13 | | −7.714 | (ASP) | 2.267 | | | | |
| 14 | Optical filter | Infinity | | 0.300 | Glass | 1.52 | 64.17 | |
| 15 | | Infinity | | 2.567 | | | | |
| 16 | Protective | Infinity | | 0.400 | Glass | 1.52 | 64.17 | |
| | element | | | | | | | |

| | | | |
|---|---|---|---|
| 17 | | Infinity | 0.278 |
| 18 | Image Plane | Infinity | — |

TABLE 2
Aspheric coefficient

| Surface | 1 | 2 | 3 | 4 | 8 |
|---|---|---|---|---|---|
| K: | 0.0000E+00 | 0.0000E+00 | 0.0000E+00 | 0.0000E+00 | 0.0000E+00 |
| A2: | 0.0000E+00 | 0.0000E+00 | 0.0000E+00 | 0.0000E+00 | 0.0000E+00 |
| A4: | 1.9060E−03 | 7.2440E−04 | −3.4529E−02 | −3.7432E−02 | −1.4150E−03 |
| A6: | −1.3642E−04 | −4.6579E−04 | 6.8878E−03 | 8.9293E−03 | 6.0570E−04 |
| A8: | 5.6010E−06 | 2.0047E−04 | −1.1104E−03 | −1.7711E−03 | −3.3363E−04 |
| A10: | −1.2831E−07 | −5.9064E−05 | 1.0976E−04 | 2.3235E−04 | 9.3332E−05 |
| A12: | 1.5979E−09 | 6.5919E−06 | −5.1828E−06 | −1.7313E−05 | −1.2342E−05 |
| A14: | −8.4029E−12 | −3.2084E−07 | 6.1020E−08 | 5.3640E−07 | 6.6256E−07 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |
| Surface | 9 | 10 | 11 | 12 | 13 |
| K: | 0.0000E+00 | −1.6179E+01 | 3.7789E+00 | 7.7771E−02 | −1.8032E+00 |
| A2: | 0.0000E+00 | 0.0000E+00 | 0.0000E+00 | 0.0000E+00 | 0.0000E+00 |
| A4: | −1.0165E−02 | −2.4583E−02 | −3.4253E−02 | −1.5747E−02 | 3.5693E−04 |
| A6: | 3.2493E−03 | 7.2808E−03 | 7.7581E−03 | 1.6902E−03 | −4.2216E−04 |
| A8: | −1.1727E−03 | −2.0528E−03 | −1.6466E−03 | −3.8663E−05 | 1.0223E−04 |
| A10: | 2.8147E−04 | 3.9445E−04 | 2.0132E−04 | −3.9865E−05 | −7.2951E−06 |
| A12: | −3.4637E−05 | −4.2467E−05 | −1.3668E−05 | 5.8501E−06 | −6.4041E−07 |
| A14: | 1.7097E−06 | 1.8770E−06 | 3.3996E−07 | −2.3770E−07 | 1.0301E−07 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |

Table 1 shows detailed configuration data of the first embodiment in FIG. 1A. Units of the curvature radius, the central thickness, the gap, and the focal length is mm. Surfaces 0 to 16 sequentially represent surfaces from an object side to an image side. Surface 7 is a gap between the stop 100 and the object-side surface 141 of the fourth lens 140 along the optical axis 190. The stop 100 is closer to the object side than the object-side surface 141 of the fourth lens 140, and therefore the stop 100 is represented by a positive value. Otherwise, if the object-side surface 141 of the fourth lens 140 is closer to the object side than the stop 100, the stop 100 is represented by a negative value. Surfaces 1, 3, 5, 8, 10, 12, 14 and 16 are respectively central thicknesses of the first lens 110, the second lens 120, the third lens 130, the fourth lens 140, the fifth lens 150, the sixth lens 160, the optical filter 171 and the protective element 172 along the optical axis 190. Surfaces 2, 4, 6, 9, 11, 13, 15 and 17 respectively are a gap between the first lens 110 and the second lens 120 the stop 100 along the optical axis 190, a gap between the second lens 120 and the third lens 130 along the optical axis 190, a gap between the third lens 130 and the stop 100, a gap between the fourth lens 140 and the fifth lens 150 along the optical axis 190, a gap between the fifth lens 150 and the sixth lens 160 along the optical axis 190, a gap between the sixth lens 160 and the optical filter 171 along the optical axis 190, a gap between the optical filter 171 and the protective element 172 along the optical axis 190, and a gap between the protective element 172 and the image plane 180 along the optical axis 190.

Table 2 shows aspheric data in the first embodiment. k represents a conic constant in an aspheric curve equation, and A2, A4, A6, A8, A10, A12, A14, A16, A18, A20, A22 and A24 are high-order aspheric coefficients. In addition, the following tables of embodiments are schematic diagrams and aberration curves corresponding to the embodiments. The definitions of data in the tables of the embodiments are the same as the definitions in Table 1 and Table 2 of the first embodiment, and are not repeated herein.

### Second Embodiment

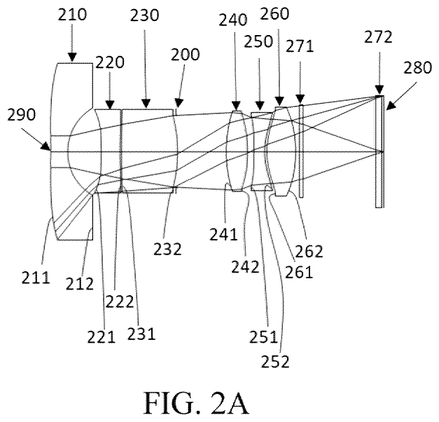

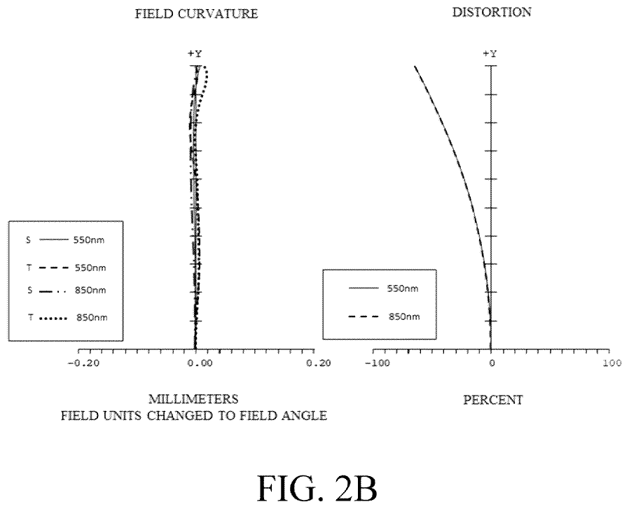

Refer to FIG. 2A and FIG. 2B. FIG. 2A is a schematic view of an optical lens assembly according to a second embodiment of the present disclosure, and FIG. 2B shows a field curvature curve and a distortion curve of an optical lens assembly according to a second embodiment. As can be seen from FIG. 2A, the optical lens assembly includes, in order from an object side to an image side: a first lens 210, a second lens 220, a third lens 230, a stop 200, a fourth lens 240, a fifth lens 250, a sixth lens 260, an optical filter 271, a protective element 272, and an image plane 280. A total quantity of lenses with refractive power in the optical lens assembly is six, but not limited thereto.

The first lens 210 with negative refractive power is made of a plastic material and includes an object-side surface 211 and an image-side surface 212, wherein the object-side surface 211 of the first lens 210 is concave near an optical axis 290, and the image-side surface 212 of the first lens 210 is concave near the optical axis 290. The object-side surface 211 and the image-side surface 212 are aspheric.

The second lens 220 with negative refractive power is made of a plastic material and includes an object-side surface 221 and an image-side surface 222, wherein the object-side surface 221 of the second lens 220 is concave near the optical axis 290, and the image-side surface 222 of the second lens 220 is concave near the optical axis 290. The object-side surface 221 and the image-side surface 222 are aspheric.

The third lens 230 with positive refractive power is made of a glass material and includes an object-side surface 231 and an image-side surface 232, wherein the object-side surface 231 of the third lens 230 is convex near an optical axis 290, and the image-side surface 232 of the third lens 230 is convex near the optical axis 290. The object-side surface 231 and the image-side surface 232 are aspheric.

The fourth lens 240 with positive refractive power is made of a plastic material and includes an object-side surface 241 and an image-side surface 242, wherein the object-side surface 241 of the fourth lens 240 is convex near an optical axis 290, and the image-side surface 242 of the fourth lens 240 is convex near the optical axis 290. The object-side surface 241 and the image-side surface 242 are aspheric.

The fifth lens 250 with negative refractive power is made of a plastic material and includes an object-side surface 251 and an image-side surface 252, wherein the object-side surface 251 of the fifth lens 250 is convex near the optical axis 290, and the image-side surface 252 of the fifth lens 250 is concave near the optical axis 290. The object-side surface 251 and the image-side surface 252 are aspheric.

The sixth lens 260 with positive refractive power is made of a plastic material and includes an object-side surface 261 and an image-side surface 262, wherein the object-side surface 261 of the sixth lens 260 is convex near the optical axis 290, and the image-side surface 262 of the sixth lens 260 is convex near the optical axis 290. The object-side surface 261 and the image-side surface 262 are aspheric.

The optical filter 271 is made of glass, and is disposed between the sixth lens 260 and the image plane 280 without affecting a focal length of the optical lens assembly. In this embodiment, the optical filter 271 may be an optical filter that allows the visible light to pass, an optical filter that allows the infrared light to pass, or an optical filter that allows the visible light and the infrared light to pass simultaneously.

The protective element 272 is made of glass, and is disposed between the optical filter 271 and the image plane 280 without affecting a focal length of the optical lens assembly.

Refer to Table 3 and Table 4 below.

TABLE 3
Second embodiment
f (focal length) = 3.20 mm (millimeters), Fno (f-number) = 1.63,
FOV (field of view) = 144.00° (degrees)

| | | | | Central | | | Abbe | Focal |
|---|---|---|---|---|---|---|---|---|
| | | Curvature radius | | thickness/ | | Refractive | number | length |
| Surface | | (mm) | | gap (mm) | Material | index (nd) | (vd) | (mm) |
| 0 | Object | Infinity | | Infinity | | | | |
| 1 | First lens | −84.259 | (ASP) | 1.113 | Plastic | 1.54 | 55.99 | −5.14 |
| 2 | | 2.920 | (ASP) | 2.270 | | | | |
| 3 | Second lens | −48.657 | (ASP) | 1.187 | Plastic | 1.68 | 18.15 | −12.75 |
| 4 | | 10.846 | (ASP) | 0.156 | | | | |
| 5 | Third lens | 70.962 | | 3.726 | Glass | 2.00 | 25.43 | 7.81 |
| 6 | | −8.644 | | −0.113 | | | | |
| 7 | Stop | Infinity | | 3.363 | | | | |
| 8 | Fourth lens | 7.382 | (ASP) | 1.439 | Plastic | 1.54 | 55.99 | 7.89 |
| 9 | | −9.656 | (ASP) | 0.398 | | | | |
| 10 | Fifth lens | 249.544 | (ASP) | 0.722 | Plastic | 1.66 | 20.37 | −5.75 |
| 11 | | 3.781 | (ASP) | 0.174 | | | | |
| 12 | Sixth lens | 4.138 | (ASP) | 1.915 | Plastic | 1.54 | 55.99 | 5.10 |
| 13 | | −7.145 | (ASP) | 0.226 | | | | |
| 14 | Optical filter | Infinity | | 0.300 | Glass | 1.52 | 64.17 | |
| 15 | | Infinity | | 4.833 | | | | |
| 16 | Protective | Infinity | | 0.400 | Glass | 1.52 | 64.17 | |
| | element | | | | | | | |

| | | | |
|---|---|---|---|
| 17 | | Infinity | 0.137 |
| 18 | Image Plane | Infinity | — |

TABLE 4
Aspheric coefficient

| Surface | 1 | 2 | 3 | 4 | 8 |
|---|---|---|---|---|---|
| K: | 0.0000E+00 | 0.0000E+00 | 1.1916E+03 | 0.0000E+00 | 0.0000E+00 |
| A2: | 0.0000E+00 | 0.0000E+00 | 0.0000E+00 | 0.0000E+00 | 0.0000E+00 |
| A4: | 1.3140E−03 | −1.6984E−03 | −1.4539E−02 | −1.0312E−02 | −1.0869E−03 |
| A6: | −4.5440E−05 | −6.7301E−06 | 8.3957E−04 | 1.0533E−03 | 6.5631E−05 |
| A8: | 1.0384E−06 | −1.0553E−05 | −1.6673E−05 | −4.1978E−05 | 2.7599E−06 |
| A10: | −4.0638E−09 | 4.3957E−07 | −2.4089E−07 | −1.7110E−07 | 7.9642E−07 |
| A12: | −2.6959E−10 | −1.8594E−07 | −1.8024E−07 | −3.4934E−08 | 1.5404E−08 |
| A14: | 4.5679E−12 | −1.4255E−08 | 1.7456E−08 | 1.4368E−08 | −2.3085E−08 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |
| Surface | 9 | 10 | 11 | 12 | 13 |
| K: | 0.0000E+00 | −1.6179E+01 | 3.7789E+00 | −1.0092E−01 | 2.0439E+00 |
| A2: | 0.0000E+00 | 0.0000E+00 | 0.0000E+00 | 0.0000E+00 | 0.0000E+00 |
| A4: | −3.7629E−03 | −7.8661E−03 | −1.0829E−02 | −7.9682E−03 | −3.5982E−04 |
| A6: | 9.7352E−05 | −1.4537E−04 | 1.4199E−04 | 2.3511E−04 | −6.4714E−05 |
| A8: | 2.4633E−05 | 4.8815E−05 | −6.2909E−06 | −2.0566E−05 | 2.8255E−05 |
| A10: | −9.8401E−07 | −3.2904E−06 | −5.3626E−07 | −5.0443E−07 | −2.8714E−06 |
| A12: | −1.1060E−07 | −1.0296E−07 | −1.7229E−07 | 6.9618E−09 | 2.5949E−08 |
| A14: | −1.7777E−08 | −2.2059E−08 | 1.1061E−08 | 6.0108E−09 | 9.8805E−09 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |

In the second embodiment, an aspheric curve equation is expressed as that in the first embodiment. In addition, definitions of parameters in the following tables are the same as those in the first embodiment, and are not repeated herein.

Referring to Table 3 and Table 4, the following data may be calculated:

Second embodiment

| | | | |
|---|---|---|---|
| (nd3*CT3)/EPD | 3.79 | R9/(f4*f5) | −5.51 mm⁻¹ |
| vd3/(nd3*f3) | 1.63 mm⁻¹ | f2/f3 | −1.63 |
| (vd3*ΣAT)/ | 10.16 | CRA*R9/FOV | 25.23 mm |
| (nd3*f3) | | | |
| f456/f*EPD | 1.08 mm⁻¹ | tan(CRA)*R5/IMH | 5.29 |
| ΣAT*CT3/(CT2) | 19.61 mm | (CT4 + CT5 + CT6)* | 6.74 mm |
| | | EPD/CT2 | |
| (R5/R7)*EPD | 18.88 mm | (CRA*R7)/ | 0.02°/mm⁻² |
| | | (R9*BFL*f) | |
| TL/(T23 + T56) | 67.47 | (R1/R4)*BFL | −45.80 mm |
| R5/R6 | −8.21 | (FOV/R1)*R5 | −121.28° |
| f3*CT3/R5 | 0.41 mm | | |

### Third Embodiment

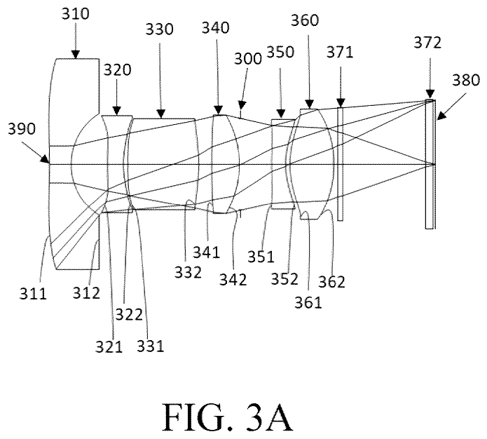

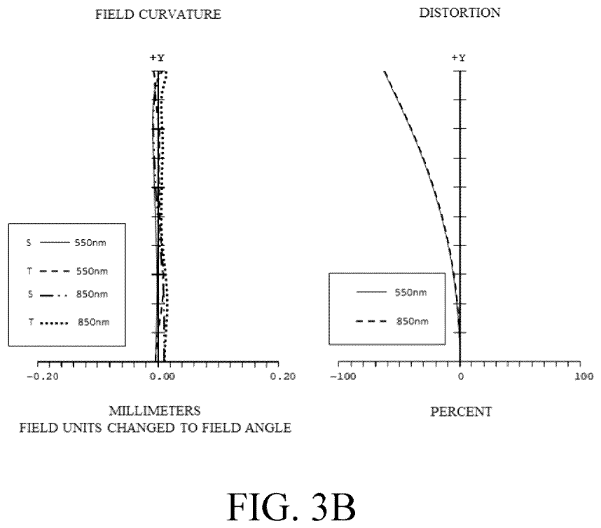

Refer to FIG. 3A and FIG. 3B. FIG. 3A is a schematic view of an optical lens assembly according to a third embodiment of the present disclosure, and FIG. 3B shows a field curvature curve and a distortion curve of an optical lens assembly according to a second embodiment. As can be seen from FIG. 3A, the optical lens assembly includes, in order from an object side to an image side: a first lens 310, a second lens 320, a third lens 330, a fourth lens 340, a stop 300, a fifth lens 350, a sixth lens 360, an optical filter 371, a protective element 372, and an image plane 380. A total quantity of lenses with refractive power in the optical lens assembly is six, but not limited thereto.

The first lens 310 with negative refractive power is made of a plastic material and includes an object-side surface 311 and an image-side surface 312, wherein the object-side surface 311 of the first lens 310 is concave near an optical axis 390, and the image-side surface 312 of the first lens 310 is concave near the optical axis 390. The object-side surface 311 and the image-side surface 312 are aspheric.

The second lens 320 with negative refractive power is made of a plastic material and includes an object-side surface 321 and an image-side surface 322, wherein the object-side surface 321 of the second lens 320 is convex near the optical axis 390, and the image-side surface 322 of the second lens 320 is concave near the optical axis 390. The object-side surface 321 and the image-side surface 322 are aspheric.

The third lens 330 with positive refractive power is made of a plastic material and includes an object-side surface 331 and an image-side surface 332, wherein the object-side surface 331 of the third lens 330 is convex near an optical axis 390, and the image-side surface 332 of the third lens 330 is convex near the optical axis 390. The object-side surface 331 and the image-side surface 332 are aspheric.

The fourth lens 340 with positive refractive power is made of a glass material and includes an object-side surface 341 and an image-side surface 342, wherein the object-side surface 341 of the fourth lens 340 is convex near an optical axis 390, and the image-side surface 342 of the fourth lens 340 is convex near the optical axis 390. The object-side surface 341 and the image-side surface 342 are aspheric.

The fifth lens 350 with negative refractive power is made of a plastic material and includes an object-side surface 351 and an image-side surface 352, wherein the object-side surface 351 of the fifth lens 350 is convex near the optical axis 390, and the image-side surface 352 of the fifth lens 350 is concave near the optical axis 390. The object-side surface 351 and the image-side surface 352 are aspheric.

The sixth lens 360 with positive refractive power is made of a plastic material and includes an object-side surface 361 and an image-side surface 362, wherein the object-side surface 361 of the sixth lens 360 is convex near the optical axis 390, and the image-side surface 362 of the sixth lens 360 is convex near the optical axis 390. The object-side surface 361 and the image-side surface 362 are aspheric.

The optical filter 371 is made of glass, and is disposed between the sixth lens 360 and the image plane 380 without affecting a focal length of the optical lens assembly. In this embodiment, the optical filter 371 may be an optical filter that allows the visible light to pass, an optical filter that allows the infrared light to pass, or an optical filter that allows the visible light and the infrared light to pass simultaneously.

The protective element 372 is made of glass, and is disposed between the optical filter 371 and the image plane 380 without affecting a focal length of the optical lens assembly.

Refer to Table 5 and Table 6 below.

TABLE 5
Third embodiment
f (focal length) = 3.21 mm (millimeters), Fno (f-number) = 1.63,
FOV (field of view) = 142.00° (degrees)

| | | | | Central | | | Abbe | Focal |
|---|---|---|---|---|---|---|---|---|
| | | Curvature radius | | thickness/ | | Refractive | number | length |
| Surface | | (mm) | | gap (mm) | Material | index (nd) | (vd) | (mm) |
| 0 | Object | Infinity | | Infinity | | | | |
| 1 | First lens | −27.180 | (ASP) | 1.206 | Plastic | 1.54 | 55.99 | −4.87 |
| 2 | | 2.997 | (ASP) | 2.130 | | | | |
| 3 | Second lens | 8.810 | (ASP) | 0.917 | Plastic | 1.66 | 20.37 | −13.81 |
| 4 | | 4.319 | (ASP) | 0.236 | | | | |
| 5 | Third lens | 24.801 | (ASP) | 4.091 | Plastic | 1.67 | 19.24 | 10.70 |
| 6 | | −9.580 | (ASP) | 0.774 | | | | |
| 7 | Fourth lens | 37.569 | | 1.574 | Glass | 1.57 | 71.30 | 7.73 |
| 8 | | −4.922 | | 0.100 | | | | |
| 9 | Stop | Infinity | | 1.794 | | | | |
| 10 | Fifth lens | 19.107 | (ASP) | 0.785 | Plastic | 1.67 | 19.24 | −6.51 |
| 11 | | 3.527 | (ASP) | 0.248 | | | | |
| 12 | Sixth lens | 4.477 | (ASP) | 2.519 | Plastic | 1.54 | 55.99 | 4.97 |
| 13 | | −5.530 | (ASP) | 0.240 | | | | |
| 14 | Optical filter | Infinity | | 0.300 | Glass | 1.52 | 64.17 | |
| 15 | | Infinity | | 4.797 | | | | |
| 16 | Protective | Infinity | | 0.400 | Glass | 1.52 | 64.17 | |
| | element | | | | | | | |

| | | | |
|---|---|---|---|
| 17 | | Infinity | 0.160 |
| 18 | Image Plane | Infinity | 0.000 |

TABLE 6
Aspheric coefficient

| Surface | 1 | 2 | 3 | 4 | 5 |
|---|---|---|---|---|---|
| K: | 0.0000E+00 | 0.0000E+00 | 0.0000E+00 | 0.0000E+00 | 0.0000E+00 |
| A2: | 0.0000E+00 | 0.0000E+00 | 0.0000E+00 | 0.0000E+00 | 0.0000E+00 |
| A4: | 2.4796E−03 | −1.7805E−03 | −2.5239E−02 | −2.0654E−02 | 5.8110E−03 |
| A6: | −1.1924E−04 | 1.5780E−04 | 8.6281E−04 | 3.1282E−03 | 6.3220E−04 |
| A8: | 3.5684E−06 | 9.4440E−07 | 1.3520E−04 | −1.4667E−04 | −9.4626E−05 |
| A10: | −4.6695E−08 | −5.4245E−06 | −1.1076E−05 | −1.3554E−07 | 1.8574E−06 |
| A12: | −8.4795E−12 | −8.4521E−08 | −2.3509E−08 | −3.1433E−08 | 1.2936E−10 |
| A14: | 4.7460E−12 | −8.5484E−10 | 1.3064E−08 | 8.0644E−09 | 3.7846E−13 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |
| Surface | 6 | 10 | 11 | 12 | 13 |
| K: | 0.0000E+00 | 0.0000E+00 | 0.0000E+00 | 4.4237E−01 | 1.4247E+00 |
| A2: | 0.0000E+00 | 0.0000E+00 | 0.0000E+00 | 0.0000E+00 | 0.0000E+00 |
| A4: | 2.0922E−03 | −7.5470E−03 | −1.2630E−02 | −5.7074E−03 | 5.5657E−04 |
| A6: | 4.2996E−05 | 3.7334E−04 | 4.7691E−04 | −1.2807E−04 | 3.0776E−06 |
| A8: | −2.3308E−06 | −4.0092E−05 | −4.3687E−05 | 1.3810E−05 | 9.5974E−06 |
| A10: | 3.4797E−07 | 6.7699E−07 | 1.9507E−07 | −1.5110E−06 | −1.5236E−07 |
| A12: | 1.2904E−10 | 1.0849E−08 | −7.6309E−09 | −2.5515E−08 | 7.6263E−10 |
| A14: | 4.8782E−13 | −2.9114E−09 | −1.7026E−09 | −2.1135E−09 | 8.5636E−10 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |

In the third embodiment, an aspheric curve equation is expressed as that in the first embodiment. In addition, definitions of parameters in the following tables are the same as those in the first embodiment, and are not repeated herein.

Referring to Table 5 and Table 6, the following data may be calculated:

Third embodiment

| | | | |
|---|---|---|---|
| (nd3*CT3)/ | 3.47 | R9/(f4*f5) | −0.38 mm⁻¹ |
| EPD | | | |
| vd3/(nd3*f3) | 1.08 mm⁻¹ | f2/f3 | −1.29 |
| (vd3*ΣAT)/ | 5.68 | CRA*R9/FOV | 1.94 mm |
| (nd3*f3) | | | |
| f456/f*EPD | 1.01 mm⁻¹ | tan(CRA)* | 1.84 |
| | | R5/IMH | |
| ΣAT*CT3/ | 23.58 mm | (CT4 + CT5 + | 10.49 mm |
| (CT2) | | CT6)* | |
| | | EPD/CT2 | |
| (R5/R7)*EPD | 1.30 mm | (CRA*R7)/ | 1.49°/mm² |
| | | (R9*BFL*f) | |
| TL/(T23 + T56) | 46.03 | (R1/R4)*BFL | −37.10 mm |
| R5/R6 | −2.59 | (FOV/R1)*R5 | −129.57° |
| f3*CT3/R5 | 1.76 mm | | |

### Fourth Embodiment

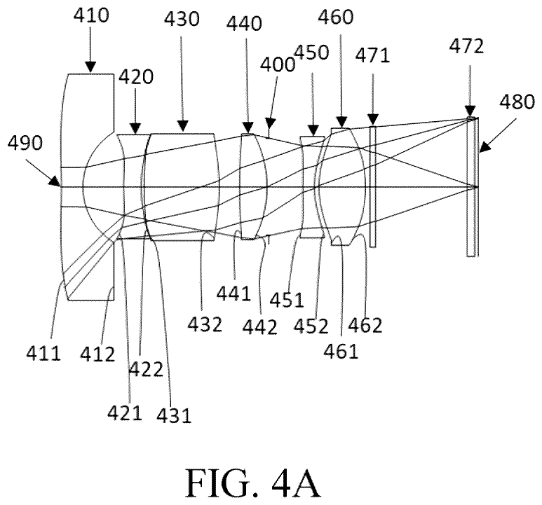

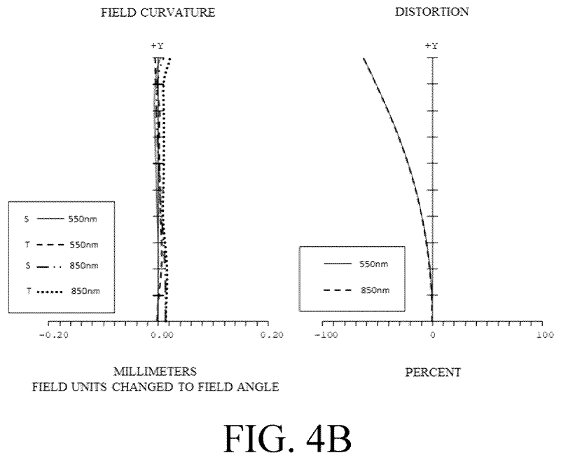

Refer to FIG. 4A and FIG. 4B. FIG. 4A is a schematic view of an optical lens assembly according to a fourth embodiment of the present disclosure, and FIG. 4B shows a field curvature curve and a distortion curve of an optical lens assembly according to a second embodiment. As can be seen from FIG. 4A, the optical lens assembly includes, in order from an object side to an image side: a first lens 410, a second lens 420, a third lens 430, a fourth lens 440, a stop 400, a fifth lens 450, a sixth lens 460, an optical filter 471, a protective element 472, and an image plane 480. A total quantity of lenses with refractive power in the optical lens assembly is six, but not limited thereto.

The first lens 410 with negative refractive power is made of a plastic material and includes an object-side surface 411 and an image-side surface 412, wherein the object-side surface 411 of the first lens 410 is concave near an optical axis 490, and the image-side surface 412 of the first lens 410 is concave near the optical axis 490. The object-side surface 411 and the image-side surface 412 are aspheric.

The second lens 420 with negative refractive power is made of a plastic material and includes an object-side surface 421 and an image-side surface 422, wherein the object-side surface 421 of the second lens 420 is convex near the optical axis 490, and the image-side surface 422 of the second lens 420 is concave near the optical axis 490. The object-side surface 421 and the image-side surface 422 are aspheric.

The third lens 430 with positive refractive power is made of a plastic material and includes an object-side surface 431 and an image-side surface 432, wherein the object-side surface 431 of the third lens 430 is convex near an optical axis 490, and the image-side surface 432 of the third lens 430 is convex near the optical axis 490. The object-side surface 431 and the image-side surface 432 are aspheric.

The fourth lens 440 with positive refractive power is made of a glass material and includes an object-side surface 441 and an image-side surface 442, wherein the object-side surface 441 of the fourth lens 440 is convex near an optical axis 490, and the image-side surface 442 of the fourth lens 440 is convex near the optical axis 490. The object-side surface 441 and the image-side surface 442 are aspheric.

The fifth lens 450 with negative refractive power is made of a plastic material and includes an object-side surface 451 and an image-side surface 452, wherein the object-side surface 451 of the fifth lens 450 is convex near the optical axis 490, and the image-side surface 452 of the fifth lens 450 is concave near the optical axis 490. The object-side surface 451 and the image-side surface 452 are aspheric.

The sixth lens 460 with positive refractive power is made of a plastic material and includes an object-side surface 461 and an image-side surface 462, wherein the object-side surface 461 of the sixth lens 460 is convex near the optical axis 490, and the image-side surface 462 of the sixth lens 460 is convex near the optical axis 490. The object-side surface 461 and the image-side surface 462 are aspheric.

The optical filter 471 is made of glass, and is disposed between the sixth lens 460 and the image plane 380 without affecting a focal length of the optical lens assembly. In this embodiment, the optical filter 471 may be an optical filter that allows the visible light to pass, an optical filter that allows the infrared light to pass, or an optical filter that allows the visible light and the infrared light to pass simultaneously.

The protective element 472 is made of glass, and is disposed between the optical filter 471 and the image plane 480 without affecting a focal length of the optical lens assembly.

Refer to Table 7 and Table 8 below.

TABLE 7
Fourth embodiment
f (focal length) = 3.21 mm (millimeters), Fno (f-number) = 1.65,
FOV (field of view) = 141.70° (degrees)

| | | | | Central | | | Abbe | Focal |
|---|---|---|---|---|---|---|---|---|
| | | Curvature radius | | thickness/ | | Refractive | number | length |
| Surface | | (mm) | | gap (mm) | Material | index (nd) | (vd) | (mm) |
| 0 | Object | Infinity | | Infinity | | | | |
| 1 | First lens | −31.156 | (ASP) | 1.203 | Plastic | 1.54 | 55.99 | −4.97 |
| 2 | | 3.017 | (ASP) | 2.151 | | | | |
| 3 | Second lens | 8.822 | (ASP) | 0.891 | Plastic | 1.66 | 20.37 | −15.04 |
| 4 | | 4.507 | (ASP) | 0.241 | | | | |
| 5 | Third lens | 47.400 | (ASP) | 3.968 | Plastic | 1.67 | 19.24 | 11.17 |
| 6 | | −8.720 | (ASP) | 1.095 | | | | |
| 7 | Fourth lens | 36.340 | | 1.447 | Glass | 1.59 | 68.34 | 7.86 |
| 8 | | −5.284 | | 0.100 | | | | |
| 9 | Stop | Infinity | | 1.799 | | | | |
| 10 | Fifth lens | 31.883 | (ASP) | 0.632 | Plastic | 1.67 | 19.24 | −6.35 |
| 11 | | 3.766 | (ASP) | 0.263 | | | | |
| 12 | Sixth lens | 4.510 | (ASP) | 2.453 | Plastic | 1.54 | 55.99 | 4.95 |
| 13 | | −5.465 | (ASP) | 0.286 | | | | |
| 14 | Optical filter | Infinity | | 0.300 | Glass | 1.52 | 64.17 | |
| 15 | | Infinity | | 4.842 | | | | |
| 16 | Protective | Infinity | | 0.400 | Glass | 1.52 | 64.17 | |
| | element | | | | | | | |

| | | | |
|---|---|---|---|
| 17 | | Infinity | 0.207 |
| 18 | Image Plane | Infinity | 0.000 |

TABLE 8
Aspheric coefficient

| Surface | 1 | 2 | 3 | 4 | 5 |
|---|---|---|---|---|---|
| K: | 0.0000E+00 | 0.0000E+00 | 0.0000E+00 | 0.0000E+00 | 0.0000E+00 |
| A2: | 0.0000E+00 | 0.0000E+00 | 0.0000E+00 | 0.0000E+00 | 0.0000E+00 |
| A4: | 2.3627E−03 | −1.4222E−03 | −2.4975E−02 | −2.1116E−02 | 5.4534E−03 |
| A6: | −1.1446E−04 | 1.1844E−04 | 7.9265E−04 | 3.0343E−03 | 6.3913E−04 |
| A8: | 3.3868E−06 | 7.2187E−06 | 1.4099E−04 | −1.3766E−04 | −9.2635E−05 |
| A10: | −4.2691E−08 | −5.4245E−06 | −1.1150E−05 | −5.2599E−07 | 1.7634E−06 |
| A12: | −4.4340E−11 | −8.4521E−08 | −2.3509E−08 | −3.1433E−08 | 1.2936E−10 |
| A14: | 4.7460E−12 | −8.5484E−10 | 1.3064E−08 | 8.0644E−09 | 3.7846E−13 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |
| Surface | 6 | 10 | 11 | 12 | 13 |
| K: | 0.0000E+00 | 0.0000E+00 | 0.0000E+00 | 4.6275E−01 | 1.3529E+00 |
| A2: | 0.0000E+00 | 0.0000E+00 | 0.0000E+00 | 0.0000E+00 | 0.0000E+00 |
| A4: | 2.0930E−03 | −7.0504E−03 | −1.1303E−02 | −5.8053E−03 | 4.5238E−04 |
| A6: | 3.2129E−05 | 3.4713E−04 | 4.6581E−04 | −6.3627E−05 | 5.0365E−05 |
| A8: | −3.6797E−06 | −4.8967E−05 | −4.4090E−05 | 1.2007E−05 | 1.7967E−06 |
| A10: | 3.7786E−07 | 9.1423E−07 | 4.8222E−07 | −1.0238E−06 | 8.7700E−07 |
| A12: | 1.2904E−10 | 1.0849E−08 | −7.6309E−09 | −2.5515E−08 | 7.6263E−10 |
| A14: | 4.8782E−13 | −2.9114E−09 | −1.7026E−09 | −2.1135E−09 | 8.5636E−10 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |

In the Fourth embodiment, an aspheric curve equation is expressed as that in the first embodiment. In addition, definitions of parameters in the following tables are the same as those in the first embodiment, and are not repeated herein.

Referring to Table 7 and Table 8, the following data may be calculated:

Fourth embodiment

| | | | |
|---|---|---|---|
| (nd3*CT3)/EPD | 3.41 | R9/(f4*f5) | −0.64 mm⁻¹ |
| vd3/(nd3*f3) | 1.03 mm⁻¹ | f2/f3 | −1.35 |
| (vd3*ΣAT)/ | 5.82 | CRA*R9/FOV | 3.17 mm |
| (nd3*f3) | | | |
| f456/f*EPD | 1.04 mm⁻¹ | tan(CRA)*R5/IMH | 3.44 |
| ΣAT*CT3/ | 25.15 mm | (CT4 + CT5 + CT6)* | 9.90 mm |
| (CT2) | | EPD/CT2 | |
| (R5/R7)*EPD | 2.54 mm | (CRA*R7)/ | 0.83°/mm² |
| | | (R9*BFL*f) | |
| TL/(T23 + T56) | 44.15 | (R1/R4)*BFL | −41.72 mm |
| R5/R6 | −5.44 | (FOV/R1)*R5 | −215.58° |
| f3*CT3/R5 | 0.94 mm | | |

### Fifth Embodiment

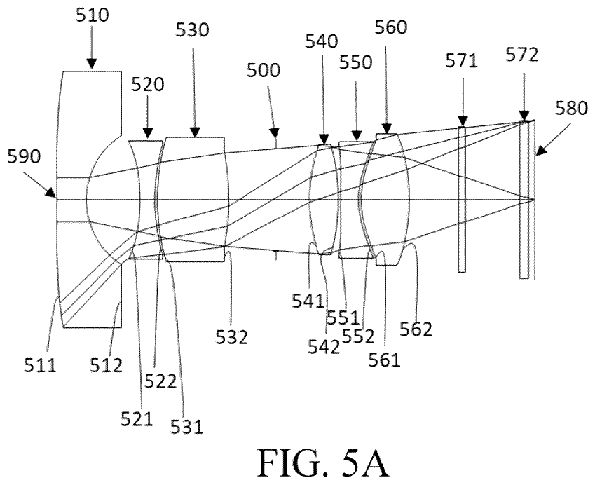

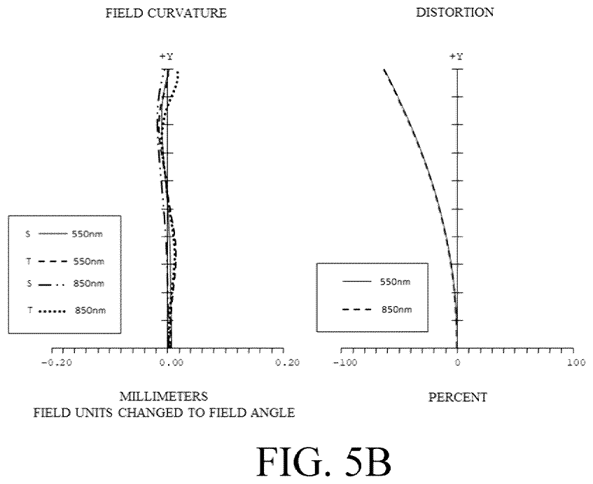

Refer to FIG. 5A and FIG. 5B. FIG. 5A is a schematic view of an optical lens assembly according to a fifth embodiment of the present disclosure, and FIG. 5B shows a field curvature curve and a distortion curve of an optical lens assembly according to a second embodiment. As can be seen from FIG. 5A, the optical lens assembly includes, in order from an object side to an image side: a first lens 510, a second lens 520, a third lens 530, a stop 500, a fourth lens 540, a fifth lens 550, a sixth lens 560, an optical filter 571, a protective element 572, and an image plane 580. A total quantity of lenses with refractive power in the optical lens assembly is six, but not limited thereto.

The first lens 510 with negative refractive power is made of a plastic material and includes an object-side surface 511 and an image-side surface 512, wherein the object-side surface 511 of the first lens 510 is concave near an optical axis 590, and the image-side surface 512 of the first lens 510 is concave near the optical axis 590. The object-side surface 511 and the image-side surface 512 are aspheric.

The second lens 520 with negative refractive power is made of a plastic material and includes an object-side surface 521 and an image-side surface 522, wherein the object-side surface 521 of the second lens 520 is concave near the optical axis 590, and the image-side surface 522 of the second lens 520 is concave near the optical axis 590. The object-side surface 521 and the image-side surface 522 are aspheric.

The third lens 530 with positive refractive power is made of a glass material and includes an object-side surface 531 and an image-side surface 532, wherein the object-side surface 531 of the third lens 530 is convex near an optical axis 590, and the image-side surface 532 of the third lens 530 is convex near the optical axis 590. The object-side surface 531 and the image-side surface 532 are aspheric.

The fourth lens 540 with positive refractive power is made of a plastic material and includes an object-side surface 541 and an image-side surface 542, wherein the object-side surface 541 of the fourth lens 540 is convex near an optical axis 590, and the image-side surface 542 of the fourth lens 540 is convex near the optical axis 590. The object-side surface 541 and the image-side surface 542 are aspheric.

The fifth lens 550 with negative refractive power is made of a plastic material and includes an object-side surface 551 and an image-side surface 552, wherein the object-side surface 551 of the fifth lens 550 is convex near the optical axis 590, and the image-side surface 552 of the fifth lens 550 is concave near the optical axis 590. The object-side surface 551 and the image-side surface 552 are aspheric.

The sixth lens 560 with positive refractive power is made of a plastic material and includes an object-side surface 561 and an image-side surface 562, wherein the object-side surface 561 of the sixth lens 560 is convex near the optical axis 590, and the image-side surface 562 of the sixth lens 560 is convex near the optical axis 590. The object-side surface 561 and the image-side surface 562 are aspheric.

The optical filter 571 is made of glass, and is disposed between the sixth lens 560 and the image plane 380 without affecting a focal length of the optical lens assembly. In this embodiment, the optical filter 571 may be an optical filter that allows the visible light to pass, an optical filter that allows the infrared light to pass, or an optical filter that allows the visible light and the infrared light to pass simultaneously.

The protective element 572 is made of glass, and is disposed between the optical filter 571 and the image plane 580 without affecting a focal length of the optical lens assembly.

Refer to Table 9 and Table 10 below.

TABLE 9
Fifth embodiment
f (focal length) = 3.20 mm (millimeters), Fno (f-number) = 1.65,
FOV (field of view) = 142.40° (degrees)

| | | | | Central | | | Abbe | Focal |
|---|---|---|---|---|---|---|---|---|
| | | Curvature radius | | thickness/ | | Refractive | number | length |
| Surface | | (mm) | | gap (mm) | Material | index (nd) | (vd) | (mm) |
| 0 | Object | Infinity | | Infinity | | | | |
| 1 | First lens | −50.962 | (ASP) | 1.646 | Plastic | 1.54 | 55.99 | −5.60 |
| 2 | | 2.996 | (ASP) | 2.276 | | | | |
| 3 | Second lens | 15.834 | (ASP) | 0.631 | Plastic | 1.67 | 19.24 | −6.06 |
| 4 | | 3.575 | (ASP) | 0.227 | | | | |
| 5 | Third lens | 10.778 | | 3.445 | Glass | 1.92 | 20.88 | 5.57 |
| 6 | | −7.080 | | 2.100 | | | | |
| 7 | Stop | Infinity | | 1.549 | | | | |
| 8 | Fourth lens | 6.425 | (ASP) | 1.513 | Plastic | 1.54 | 55.99 | 7.12 |
| 9 | | −13.504 | (ASP) | 0.103 | | | | |
| 10 | Fifth lens | 14.997 | (ASP) | 0.650 | Plastic | 1.66 | 20.37 | −5.69 |
| 11 | | 3.057 | (ASP) | 0.327 | | | | |
| 12 | Sixth lens | 3.796 | (ASP) | 1.890 | Plastic | 1.54 | 55.99 | 5.09 |
| 13 | | −7.714 | (ASP) | 2.267 | | | | |
| 14 | Optical filter | Infinity | | 0.300 | Glass | 1.52 | 64.17 | |
| 15 | | Infinity | | 2.567 | | | | |
| 16 | Protective | Infinity | | 0.400 | Glass | 1.52 | 64.17 | |
| | element | | | | | | | |

| | | | |
|---|---|---|---|
| 17 | | Infinity | 0.278 |
| 18 | Image Plane | Infinity | — |

TABLE 10
Aspheric coefficient

| Surface | 1 | 2 | 3 | 4 | 8 |
|---|---|---|---|---|---|
| K: | 0.0000E+00 | 0.0000E+00 | 0.0000E+00 | 0.0000E+00 | 0.0000E+00 |
| A2: | 0.0000E+00 | 0.0000E+00 | 0.0000E+00 | 0.0000E+00 | 0.0000E+00 |
| A4: | 1.0155E−03 | −1.8960E−04 | −7.3220E−03 | −5.0808E−03 | −5.4634E−04 |
| A6: | −4.5010E−05 | 6.3159E−05 | 9.3634E−04 | 9.4302E−04 | 5.4259E−05 |
| A8: | 1.4375E−06 | −2.7241E−05 | −8.6019E−05 | −8.0386E−05 | −6.8987E−07 |
| A10: | −2.4982E−08 | 1.7986E−06 | 3.3778E−06 | 2.7534E−06 | −9.3933E−07 |
| A12: | 1.8699E−10 | −8.2383E−09 | −1.2395E−08 | 6.2462E−08 | −2.1599E−08 |
| A14: | 2.1500E−13 | −1.5288E−08 | −4.6148E−10 | −3.7671E−09 | 2.4223E−09 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |
| Surface | 9 | 10 | 11 | 12 | 13 |
| K: | 0.0000E+00 | −1.6179E+01 | 3.7789E+00 | −8.9388E−02 | 4.8558E+00 |
| A2: | 0.0000E+00 | 0.0000E+00 | 0.0000E+00 | 0.0000E+00 | 0.0000E+00 |
| A4: | −1.4523E−03 | −4.9562E−03 | −1.0588E−02 | −7.8855E−03 | 1.0372E−03 |
| A6: | −1.4963E−04 | −2.2127E−04 | 1.7590E−04 | 1.7935E−04 | −4.8754E−06 |
| A8: | 4.5540E−05 | 6.3395E−05 | −9.2842E−06 | −1.9538E−05 | 1.3248E−05 |
| A10: | −3.1033E−06 | −2.7497E−06 | −1.3388E−07 | −8.5740E−08 | −1.2050E−06 |
| A12: | −3.6280E−08 | −2.4248E−09 | −2.9706E−08 | −2.8775E−08 | −4.9146E−09 |
| A14: | 3.6964E−09 | 2.2273E−09 | −5.0472E−09 | −5.6409E−09 | 3.8086E−10 |
| A16: | 0.0000E+00 | 0.0000E+00 | 0.0000E+00 | 0.0000E+00 | 0.0000E+00 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| A22: | 0.0000E+00 | 0.0000E+00 | 0.0000E+00 | 0.0000E+00 | 0.0000E+00 |
| A24: | 0.0000E+00 | 0.0000E+00 | 0.0000E+00 | 0.0000E+00 | 0.0000E+00 |

In the Fifth embodiment, an aspheric curve equation is expressed as that in the first embodiment. In addition, definitions of parameters in the following tables are the same as those in the first embodiment, and are not repeated herein.

Referring to Table 9 and Table 10, the following data may be calculated:

Fifth embodiment

| | | | |
|---|---|---|---|
| (nd3*CT3)/EPD | 3.30 | R9/(f4*f5) | −0.95 mm⁻¹ |
| vd3/(nd3*f3) | 1.95 mm⁻¹ | f2/f3 | −1.09 |
| (vd3*ΣAT)/ | 12.84 | CRA*R9/FOV | 3.52 mm |
| (nd3*f3) | | | |
| f456/f*EPD | 1.01 mm⁻¹ | tan(CRA)*R5/IMH | 0.58 |
| ΣAT*CT3/(CT2) | 30.88 mm | (CT4 + CT5 + CT6)* | 12.07 mm |
| | | EPD/CT2 | |
| (R5/R7)*EPD | 2.65 mm | (CRA*R7)/R9* | 0.11°/mm² |
| | | BFL*f) | |
| TL/(T23 + T56) | 85.34 | (R1/R4)*BFL | −88.86 mm |
| R5/R6 | −0.84 | (FOV/R1)*R5 | −10.96° |
| f3*CT3/R5 | 2.12 mm | | |

### Sixth Embodiment

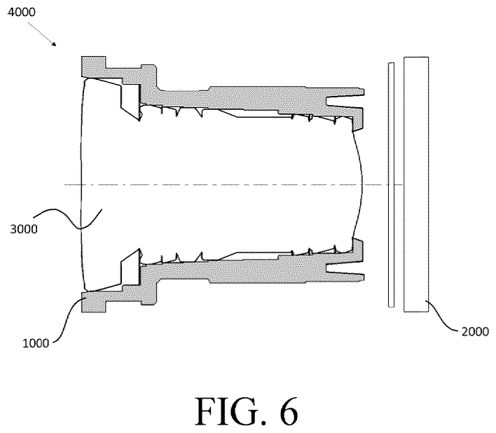

Refer to FIG. 6. FIG. 6 is a schematic view of a photographing module 4000 according to an eighth embodiment of the present disclosure. The photographing module includes a lens barrel 1000, an optical lens assembly 3000, and an image sensor 2000. The optical lens assembly 3000 can be the optical lens assemblies according to the above-mentioned embodiments, and the optical lens assembly 3000 is disposed in the lens barrel 1000. The image sensor 2000 is disposed on an image plane of the optical lens assembly 3000, and is an electronic photosensitive element (e.g., CMOS, CCD) with good sensitivity and low noise, so as to truly present the image quality of the optical lens assembly.

In the foregoing embodiments, those with ordinary knowledge in the art should understand that, in the optical lens assembly and the photographing module provided in the present disclosure, the lens may be made of glass or plastic. The lens made of glass can increase the degree of freedom of the configuration of the refractive power of the optical lens assembly. The lens made of glass may be made by using related technologies such as grinding, molding, or the like. The lens made of plastic can reduce the production costs.

In the optical lens assembly provided in the present disclosure, for the lens with refractive power, if the surface of the lens is convex and a position of the convex surface is not defined, it indicates that the surface of the lens is convex near the optical axis. If the surface of the lens is concave and a position of the concave surface is not defined, it indicates that the surface of the lens is concave near the optical axis.

The optical lens assembly provided in the present disclosure can be applicable to an optical system having an ultra wide angle, high image quality and miniaturization according to the requirements, and can be used in electronic imaging systems of the Internet of Things (IOT) devices in many ways, but not limited thereto.

What is claimed is:

1. An optical lens assembly comprising a stop, and in order from an object side to an image side, comprising:
a first lens with negative refractive power, comprising an object-side surface and an image-side surface, wherein the object-side surface of the first lens is concave near the optical axis;
a second lens with negative refractive power, comprising an object-side surface and an image-side surface;
a third lens with positive refractive power, comprising an object-side surface and an image-side surface;
a fourth lens with positive refractive power, comprising an object-side surface and an image-side surface;
a fifth lens with negative refractive power, comprising an object-side surface and an image-side surface; and
a sixth lens with positive refractive power, comprising an object-side surface and an image-side surface;
wherein a refractive index of the third lens is nd3, a central thickness of the third lens along the optical axis is CT3, an entrance pupil diameter of the optical lens assembly is EPD, and the following condition is satisfied: 2.64□(nd3*CT3)/EPD□4.55.

2. The optical lens assembly according to claim 1, wherein an Abbe number of the third lens is vd3, a focal length of the third lens is f3, and the following condition is satisfied: 0.82 mm⁻¹<vd3/(nd3*f3)<2.81 mm⁻¹.

3. The optical lens assembly according to claim 1, wherein an Abbe number of the third lens is vd3, a sum of the distances between any two adjacent lenses along the optical axis is ΣAT, a focal length of the third lens is f3, and the following condition is satisfied: 4.55□(vd3*ΣAT)/(nd3*f3)□18.52.

4. The optical lens assembly according to claim 1, wherein a composite focal length of the fourth lens, the fifth lens and the sixth lens is f456, a focal length of the optical lens assembly is f, and the following condition is satisfied: 0.81 mm⁻¹<f456/(f*EPD)<1.31 mm^{31 1}.

5. The optical lens assembly according to claim 1, wherein a sum of the distances between any two adjacent lenses along the optical axis is ΣAT, a central thickness of the second lens along the optical axis is CT2, and the following condition is satisfied: 15.68 mm □ΣAT*CT3/(CT2)□43.12 mm.

6. The optical lens assembly according to claim 1, wherein a curvature radius of the object-side surface of the third lens is R5, a curvature radius of the object-side surface of the fourth lens is R7, and the following condition is satisfied: 1.04 mm□(R5/R7)*EPD□22.66 mm.

7. The optical lens assembly according to claim 1, wherein a distance from the object-side surface of the first lens to the image plane along the optical axis is TL, a distance from the image-side surface of the second lens to the object-side surface of the third lens along the optical axis is T23, a distance from the image-side surface of the fifth lens to the object-side surface of the sixth lens along the optical axis is T56, and the following condition is satisfied: 32.06□TL/(T23+T56)□102.41.

8. The optical lens assembly according to claim 1, wherein a focal length of the third lens is f3, a curvature radius of the object-side surface of the third lens is R5, and the following condition is satisfied: 0.33 mm□f3*CT3/R5□2.55 mm.

9. The optical lens assembly according to claim 1, wherein a curvature radius of the object-side surface of the fifth lens is R9, a focal length of the fourth lens is f4, a focal length of the fifth lens is f5, and the following condition is satisfied: −6.61 mm⁻¹□R9/(f4*f5)□−0.25 mm⁻¹.

10. The optical lens assembly according to claim 1, wherein an incident angle where a chief ray is incident on an image plane at a maximum view angle of the optical lens assembly is CRA, a curvature radius of the object-side surface of the fifth lens is R9, a maximum field of view of the optical lens assembly is FOV, and the following condition is satisfied: 1.12 mm □CRA*R9/FOV□30.28 mm.

11. The optical lens assembly according to claim 1, wherein an incident angle where a chief ray is incident on an image plane at a maximum view angle of the optical lens assembly is CRA, a curvature radius of the object-side surface of the third lens is R5, a maximum image height of the optical lens assembly is IMH, and the following condition is satisfied: 0.47<tan(CRA)*R5/IMH<6.35.

12. The optical lens assembly according to claim 1, wherein an incident angle where a chief ray is incident on an image plane at a maximum view angle of the optical lens assembly is CRA, a curvature radius of the object-side surface of the fourth lens is R7, a curvature radius of the object-side surface of the fifth lens is R9, a distance from the image-side surface of the sixth lens to the image plane along the optical axis is BFL, a focal length of the optical lens assembly is f, and the following condition is satisfied: 0.02°/mm²<(CRA*R7)/(R9*BFL*f)<1.79°/mm².

13. The optical lens assembly according to claim 1, wherein a curvature radius of the object-side surface of the first lens is R1, a curvature radius of the image-side surface of the second lens is R4, a distance from the image-side surface of the sixth lens to the image plane along the optical axis is BFL, and the following condition is satisfied: −106.64 mm<(R1/R4)*BFL<−29.68 mm.

14. The optical lens assembly according to claim 1, wherein a maximum field of view of the optical lens assembly is FOV, a curvature radius of the object-side surface of the first lens is R1, a curvature radius of the object-side surface of the third lens is R5, and the following condition is satisfied: −258.69°<(FOV/R1)*R5<−8.76°.

15. A photographing module, comprising:
a lens barrel;
an optical lens assembly disposed in the lens barrel; and
an image sensor disposed on an image plane of the optical lens assembly,
wherein the optical lens assembly comprises a stop, and in order from an object side to an image side, comprises:
a first lens with negative refractive power, comprising an object-side surface and an image-side surface, wherein the object-side surface of the first lens is concave near the optical axis;
a second lens with negative refractive power, comprising an object-side surface and an image-side surface;
a third lens with positive refractive power, comprising an object-side surface and an image-side surface;
a fourth lens with positive refractive power, comprising an object-side surface and an image-side surface;
a fifth lens with negative refractive power, comprising an object-side surface and an image-side surface; and
a sixth lens with positive refractive power, comprising an object-side surface and an image-side surface;
wherein a refractive index of the third lens is nd3, a central thickness of the third lens along the optical axis is CT3, an entrance pupil diameter of the optical lens assembly is EPD, and the following condition is satisfied: 2.64□(nd3*CT3)/EPD□4.55.

16. The photographing module according to claim 15, wherein an Abbe number of the third lens is vd3, a sum of the distances between any two adjacent lenses along the optical axis is ΣAT, a focal length of the third lens is f3, and the following condition is satisfied: 4.55□(vd3*ΣAT)/(nd3*f3)□18.52.

17. The photographing module according to claim 15, wherein a sum of the distances between any two adjacent lenses along the optical axis is ΣAT, a central thickness of the second lens along the optical axis is CT2, and the following condition is satisfied: 15.68 mm □ΣAT*CT3/(CT2)□43.12 mm.

18. The photographing module according to claim 15, wherein an incident angle where a chief ray is incident on an image plane at a maximum view angle of the optical lens assembly is CRA, a curvature radius of the object-side surface of the fifth lens is R9, a maximum field of view of the optical lens assembly is FOV, and the following condition is satisfied: 1.12 mm□CRA*R9/FOV□130.28 mm.

19. The photographing module according to claim 15, wherein an incident angle where a chief ray is incident on an image plane at a maximum view angle of the optical lens assembly is CRA, a curvature radius of the object-side surface of the third lens is R5, a maximum image height of the optical lens assembly is IMH, and the following condition is satisfied: 0.47<tan(CRA)*R5/IMH<6.35.

20. The photographing module according to claim 15, wherein an incident angle where a chief ray is incident on an image plane at a maximum view angle of the optical lens assembly is CRA, a curvature radius of the object-side surface of the fourth lens is R7, a curvature radius of the object-side surface of the fifth lens is R9, a distance from the image-side surface of the sixth lens to the image plane along the optical axis is BFL, a focal length of the optical lens assembly is f, and the following condition is satisfied: 0.02°/mm²<(CRA*R7)/(R9*BFL*f)<1.79°/mm².
